(19) United States
(12) Patent Application Publication
(10) Pub. No.: US 2024/0053488 A1
(43) Pub. Date: Feb. 15, 2024

(54) SYSTEMS AND METHODS FOR HANDLING OUTAGES IN A GNSS RECEIVER

(71) Applicant: Samsung Electronics Co., Ltd., Suwon-si (KR)

(72) Inventor: Raul H. ETKIN, Sunnyvale, CA (US)

(21) Appl. No.: 18/160,298

(22) Filed: Jan. 26, 2023

Related U.S. Application Data
(60) Provisional application No. 63/396,571, filed on Aug. 9, 2022.

(51) Int. Cl. G01S 19/29; H04B 17/318

(52) U.S. Cl. CPC G01S 19/29; H04B 17/318

(57) ABSTRACT

A system and a method are disclosed for handling outages in a Global Navigation Satellite System receiver. In some embodiments, the method includes: determining that a measure of combined signal level is less than a threshold, the measure of combined signal level being a measure of a signal level on a first channel of a Global Navigation Satellite System receiver and measure of a signal level on a second channel of the Global Navigation Satellite System receiver; and opening a tracking loop on a third channel of the Global Navigation Satellite System receiver.

### CROSS-REFERENCE TO RELATED APPLICATION

This application claims the priority benefit under 35 U.S.C. § 119(e) of U.S. Provisional Application No. 63/396,571, filed on Aug. 9, 2022, the disclosure of which is incorporated by reference in its entirety as if fully set forth herein.

### TECHNICAL FIELD

The disclosure generally relates to Global Navigation Satellite System systems. More particularly, the subject matter disclosed herein relates to improvements to handling outages (e.g., periodic short outages) in a Global Navigation Satellite System receiver.

### SUMMARY

Global Navigation Satellite System receivers in wearable devices, such as watches, may be subject to user activities not typically experienced by mobile devices (such as mobile telephones). One such activity is swimming, in which the device may be strapped on the wrist of the user. During swimming, the device may be put in and out of the water periodically with the swimming strokes. Wireless signals may be heavily attenuated by water, so the Global Navigation Satellite System signals experience a pattern of alternating low and high attenuation depending on whether the device is in or out of the water. These low and high attenuation patterns may negatively affect the tracking loop performance, resulting, for example, in loss of track or large measurement errors. Such large measurement errors may degrade the navigation solution (including position, velocity, and time).

To solve this problem one approach is to reduce the navigation output from 1 Hz to a lower rate (e.g., 0.2 Hz) and average the navigation solutions over the last few 1 Hz solutions, outputting the average. This last approach may result in visually less jagged tracks.

One issue with the above approach is that it does not improve the quality of the Global Navigation Satellite System measurements. Moreover, averaging may result in delay, which in turn may result in position errors because the average combines recent measurements and less recent measurements.

To overcome these issues, systems and methods are described herein for allowing the tracking loops in a Global Navigation Satellite System receiver to freewheel during short outages, making possible rapid lock reacquisition at the end of the outage. Moreover, the navigation engine of the Global Navigation Satellite System receiver may continue to produce position and velocity estimates during the outage, based on the freewheeling numerically controlled oscillator, and these estimates may be relatively accurate if the outage is sufficiently short.

The above approaches improve on previous methods because they result in reduced errors relative to alternatives such as causing the tracking loops to track, during an outage, signals consisting primarily or entirely of noise.

According to an embodiment of the present disclosure, there is provided a method, including: determining that a measure of combined signal level is less than a threshold, the measure of combined signal level being a measure of a signal level on a first channel of a Global Navigation Satellite System receiver and measure of a signal level on a second channel of the Global Navigation Satellite System receiver; and opening a tracking loop on a third channel of the Global Navigation Satellite System receiver.

In some embodiments, the third channel is the first channel.

In some embodiments, the method further includes opening a tracking loop on the second channel.

In some embodiments, the measure of combined signal level is an average of a plurality of quantities including the measure of signal level on the first channel and the measure of signal level on the second channel.

In some embodiments, the measure of signal level on the first channel is based on signal energy in an early tap, a prompt tap, and a late tap for the first channel.

In some embodiments, the measure of signal level on the first channel is based on signal energy in a lower frequency tap, a center tap, and a higher frequency tap for the first channel.

In some embodiments, the measure of signal level on the first channel is based on a maximum signal energy among taps of channel in-phase and quadrature data for the first channel.

In some embodiments, the measure of signal level on the first channel is based on the maximum signal energy adjusted by noise normalization.

In some embodiments, the method further includes: determining that the measure of combined signal level is greater than the threshold; and closing the tracking loop on the third channel.

In some embodiments: the third channel is the first channel; and the method further includes closing the tracking loop on the second channel.

In some embodiments, the opening of the tracking loop is in response to the determining that the measure of combined signal level is less than the threshold.

In some embodiments, the opening of the tracking loop is further in response to freewheeling mode being enabled.

In some embodiments, the method further includes enabling freewheeling mode, in response to: detecting a set period of strong signals, or receiving an instruction to enable freewheeling mode.

In some embodiments, the method further includes disabling freewheeling mode, in response to detecting a set period of weak signals.

According to an embodiment of the present disclosure, there is provided a Global Navigation Satellite System receiver, including: one or more processors; and a memory storing instructions which, when executed by the one or more processors, cause performance of: determining that a measure of combined signal level is less than a threshold, the measure of combined signal level being a measure of a signal level on a first channel of a Global Navigation Satellite System receiver and a signal level on a second channel of the Global Navigation Satellite System receiver; and opening a tracking loop on a third channel of the Global Navigation Satellite System receiver.

In some embodiments, the third channel is the first channel.

In some embodiments, the instructions, when executed by the one or more processors, further cause performance of: opening a tracking loop on the second channel.

In some embodiments, the measure of combined signal level is an average of a plurality of quantities including a measure of signal level on the first channel and a measure of signal level on the second channel.

In some embodiments, the measure of signal level on the first channel is based on signal energy in an early tap, a prompt tap, and a late tap for the first channel.

According to an embodiment of the present disclosure, there is provided a Global Navigation Satellite System receiver, including: means for processing; and a memory storing instructions which, when executed by the means for processing, cause performance of: determining that a measure of combined signal level is less than a threshold, the measure of combined signal level being a measure of a signal level on a first channel of a Global Navigation Satellite System receiver and a signal level on a second channel of the Global Navigation Satellite System receiver; and opening a tracking loop on a third channel of the Global Navigation Satellite System receiver.

### BRIEF DESCRIPTION OF THE DRAWINGS

In the following section, the aspects of the subject matter disclosed herein will be described with reference to exemplary embodiments illustrated in the figures, in which:

FIG. 1 is a system diagram showing a plurality of satellites and a Global Navigation Satellite System receiver, in some embodiments;

FIG. 2A is a block diagram of a process flow for generating a signal level indicator, in some embodiments;

FIG. 2B is a block diagram of a portion of a Global Navigation Satellite System receiver, in some embodiments;

FIG. 3 is a flow chart of a method, in some embodiments; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

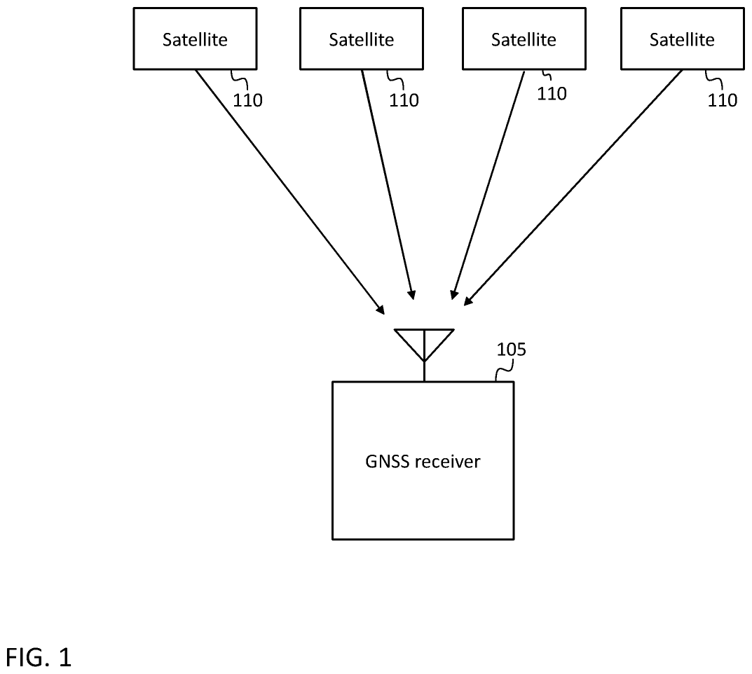

FIG. 1 shows a Global Navigation Satellite System receiver 105, and a plurality of Global Navigation Satellite System satellites (or Space Vehicles (SVs)) 110, in some embodiments. Each satellite includes a high-accuracy clock, and transmits a signal to the Global Navigation Satellite System receiver 105. The Global Navigation Satellite System receiver 105 then infers the position of the Global Navigation Satellite System receiver based on the measured time of flight of the signal from each satellite 110 and the position of each satellite. The Global Navigation Satellite System receiver 105 may also measure the frequency shift of the signal (due to the Doppler effect) and estimate, based on the measured frequency shift, the velocity of the Global Navigation Satellite System receiver 105.

When a user wears a Global Navigation Satellite System receiver 105 on her or his wrist while swimming, the Global Navigation Satellite System receiver 105 may be alternately (i) above the surface of the water, where the signal from each of a plurality of Global Navigation Satellite System satellites 110 may be strong and, (ii) below the surface of the water, where the signal from each of the plurality of Global Navigation Satellite System satellites 110 may be weak. As such, the signals in a plurality of channels of the Global Navigation Satellite System receiver 105 (each channel corresponding to a different respective satellite) may experience substantially simultaneous changes in signal level each time the Global Navigation Satellite System receiver 105 is submerged, and each time the Global Navigation Satellite System receiver 105 is raised above the surface of the water. The fact that the signals of all satellites 110 experience high or low signal levels at the same time may be used to reliably detect the times when the device is in or out of the water.

To accomplish this, a signal energy measurement algorithm may be employed in each channel, as follows. Let x(i, t, f) be the IQ value of the post-detection integration (in the case of GPS in the L1 band, the coherent integration time can be chosen to be 20 ms in one embodiment) correlator for satellite i, where t denotes the time position of the tap (i=e, p, l for early, prompt and late), and f denotes the frequency position (f=−, 0, + for minus (lower frequency), center, and plus (higher frequency)). Varying t and f results in 9 possible IQ values for satellite i. To simplify notation, the PDI (the integration interval) index is omitted.

For each satellite i, the following definition may be used:

mₘₐₓ(i)=max_{t∈{e,p,l},f∈{-,0,+}}|x(i,t,f)| (1)
where |⋅|denotes the magnitude of the complex argument. In words, mₘₐₓ(i) is the largest magnitude (or maximum signal energy) among the 9 IQ tap values for satellite i for the given PDI. This maximum signal energy may be used as a measure of the signal level in the channel. Using a maximum, over multiple time and frequency taps, as the measure of the signal level in the channel may have the advantage that it may correctly assess the signal strength in a channel even if the frequency and code delay references of the Global Navigation Satellite System receiver 105 are offset slightly from those of the received signal (e.g., as a result of temporary operation with the tracking loop open, as discussed in further detail below). In some embodiments more taps (e.g., 16 taps or 25 taps, in a square time-frequency grid, or k*j taps in a rectangular time-frequency grid) may be used, or fewer taps (e.g., the prompt tap at frequency position 0, and one tap offset in a direction in which the satellite signal is expected to drift relative to the references of the receiver, or one frequency tap and the three time-domain taps) may be used.

The following notation may be used to define the signal level at the current PDI. Cⱼ may denote the set of satellites 110 for constellation j, where j=1, 2, . . . , n, with n denoting the number of constellations supported. Cⱼ is limited to contain only the satellites 110 which are in a “good” tracking state, determined, for example as a measure of the quality of the lock, the length of time-in-track, or the magnitude of CN0. Whether a satellite is included in Cⱼ may be determined by estimating one or more such measures of performance and comparing each to a respective threshold. In some embodiments not all of the available constellations are used, and, e.g., only the constellations of a (proper) subset of the available constellations are used (e.g., only one constellation is used).

The signal level at the current PDI may be defined as

$$s = \frac{1}{k} {\sum }_{j = 1}^{n} \frac{1}{α ( j )} {\sum }_{i ∈ {C}_{j}} \frac{{m}_{max} ( i )}{\sqrt{{σ}_{i}^{2}}} \qquad ( 2 )$$

where k=Σⱼ₊₁ⁿ|Cⱼ|, with |⋅|denoting the cardinality (i.e., number of elements) of the set, and σᵢ² is the power of the noise channel for satellite i. In words, k is the number of satellites 110 in good tracking state, and s is the (weighted) average of mₘₐₓ(i) across all satellites 110, normalized by the noise standard deviation. The signal level s may be a measure of combined signal level (in all of the channels). This signal level may be used as an indication of whether the Global Navigation Satellite System receiver 105 is in a situation in which all of the channels are attenuated (e.g., as a result of the Global Navigation Satellite System receiver 105 being underwater). For example, the signal level s may be compared to a threshold T. If the signal level s is less than the threshold, the Global Navigation Satellite System receiver 105 may, for example, conclude that it is underwater (and the tracking loops of all of the channels may be opened (or left open, if they are already open), as discussed in further detail below). If the signal level s is larger than the threshold, the Global Navigation Satellite System receiver 105 may, for example, conclude that it is above the water (and the tracking loops of all of the channels may be closed (or left closed, if they are already closed), as discussed in further detail below). In a Global Navigation Satellite System receiver 105, the signals of the various constellations may be processed using different signal processing paths which introduce different gains. The normalization by the noise standard deviation attempts to remove part of the variability due to the different signal processing. Furthermore, equation (2) introduces weights α(j)≥0 to allow equalizing the signal levels for the different constellations. The threshold τ may be a fixed constant that is tuned to optimize a given performance metric. The performance metric may be, for example, the loss of lock probability, CN0, or pseudo-range or delta pseudo-range errors.

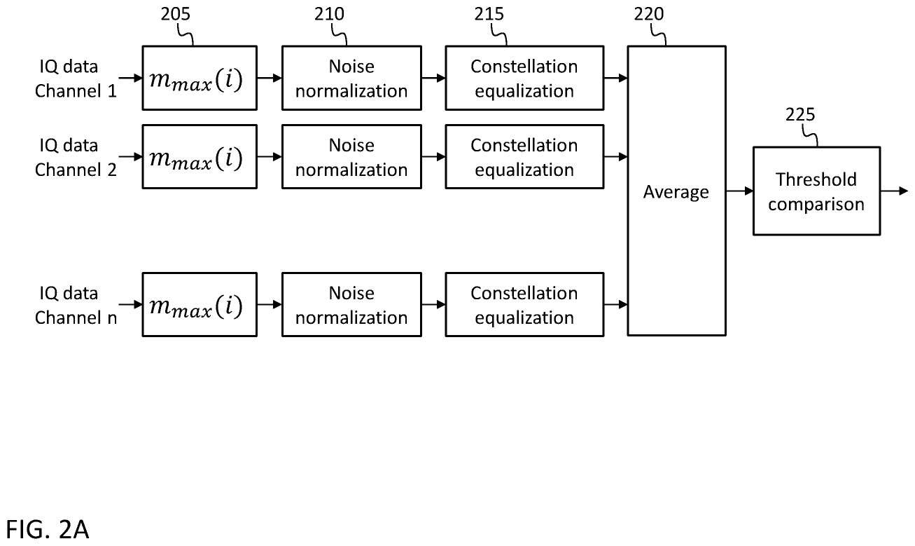

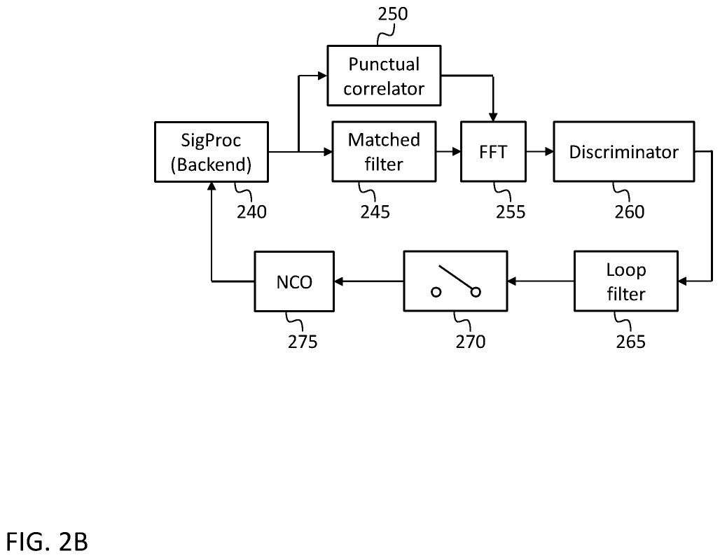

The calculation of the signal level s and its use to determine whether the Global Navigation Satellite System receiver 105 is in a situation of limited reception (e.g., underwater) is illustrated in FIG. 2A. For each channel i, (i=1, . . . , n), the nine IQ values corresponding to the combinations of the three time offsets and the three frequency offsets are fed into a first block 205 that computes the maximum magnitude mₘₐₓ(i) according to equation (1). Noise normalization (dividing by the channel noise standard deviation \sqrt{σᵢ²}) may be performed in a noise normalization block 210, and equalization across constellations (using weight 1/α(j) for constellation j) may be performed, in a constellation equalization block 215, prior to computing, in an averaging block 220, the average s of the normalized and equalized quantities across channels, according to equation (2). This average is then compared, in a threshold comparison block 225, to a threshold T, to form a signal level indicator (e.g., a binary value which indicates either that the signal level is strong or weak). The output of the threshold comparison block 225 may be used, by the Global Navigation Satellite System receiver 105, to determine whether to open or close the feedback loop in each of the tracking loops, as discussed in further detail below.

In some embodiments, an adaptive algorithm is used instead of the comparison to a fixed threshold. For example, an on-line clustering algorithm may be used to identify the two classes for the weak and strong signal levels, and a classifier may be used to determine whether the current signal level s corresponds to the strong class or the weak class.

FIG. 2B is a block diagram of a portion, corresponding to one channel, of a Global Navigation Satellite System receiver 105. A signal processing back-end 240 feeds a punctual correlator 250 and a matched filter 245, each of which feeds a fast Fourier transform (FFT) block 255. In some embodiments, additional matched filters and correlators may be present to supply the nine taps mentioned above. The FFT block 255 feeds a discriminator 260, which feeds a loop filter 265, which (when switch 270 is closed) controls a numerically controlled oscillator (NCO) 275.

The result of the signal level detection algorithm (e.g., the signal level indicator) may be used to select whether the tracking loops are closed or open (in a state that may be referred to as “freewheeling”). In some embodiments, all of the tracking loops are opened at the same time when the signal level indicator indicates a weak signal, and all of the tracking loops are closed at the same time when the signal level indicator indicates a strong signal. In the freewheeling state, the connection between the loop filter 265 and the numerically controlled oscillator 275 is broken (e.g., the switch 270 is open), and the tracking loop state variables (e.g. carrier frequency, and carrier acceleration) are used to update the NCOs, but there is no feedback from the tracking loop discriminator output and the loop filters to the tracking loop state variables.

When the tracking loops are in freewheeling mode and the signal levels are weak, modified algorithms may be used. For example, the average carrier to noise power spectral density (PSD) ratio CN0 may be computed using only the signal values last measured when the signal level indicator indicated a strong signal, and some impairment checks may be disabled to avoid clearing the track states while the signals are weak. In addition, tunnel detection at the navigation layer may be disabled to avoid confusing the weak signal levels during swimming with the effect of the Global Navigation Satellite System receiver 105 being in a tunnel.

In some embodiments freewheeling mode is disabled in some circumstances, e.g., when a set period of weak signals is detected (e.g., when the Global Navigation Satellite System receiver 105 is in a region with multiple significant obstructions to the satellite signals), and re-enabled when a set period of strong signals is detected. In some embodiments, freewheeling is disabled by default and enabled only when the Global Navigation Satellite System receiver 105 receives an instruction to enable freewheeling (e.g., an instruction from a user, or from an algorithm that detects from the location of the Global Navigation Satellite System receiver 105 that the Global Navigation Satellite System receiver 105 is at or near a swimming pool or body of water). In some embodiments, the Global Navigation Satellite System receiver 105 opens the tracking loops only when freewheeling mode is enabled. When freewheeling mode is disabled, the associated algorithm (e.g., the algorithm illustrated in FIG. 2A) may also be disabled.

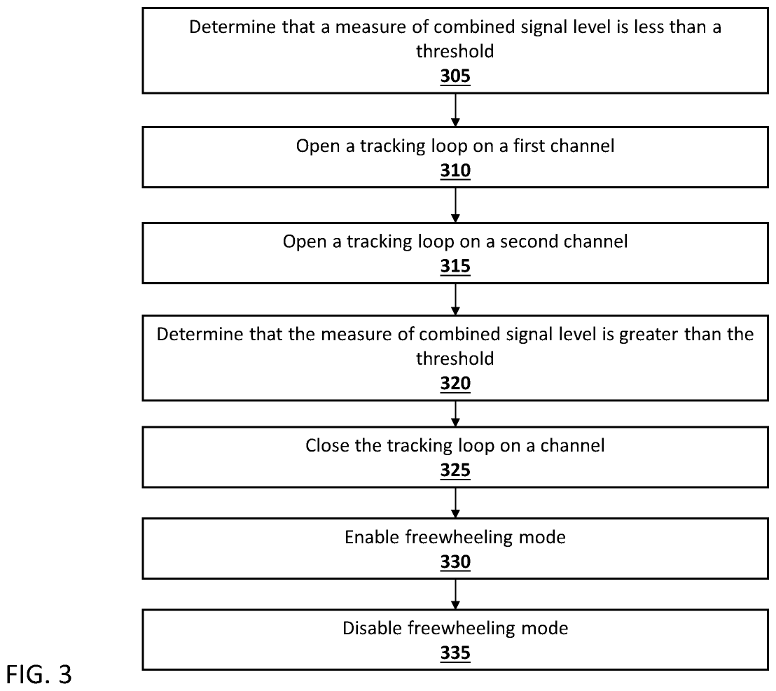

FIG. 3 is a flowchart of a method, in some embodiments. The method includes, determining, at 305, that a measure of combined signal level is less than a threshold; and opening, at 310, a tracking loop on a first channel of the Global Navigation Satellite System receiver. The method further includes opening, at 315, a tracking loop on the second channel. The opening, at 310, of the tracking loop in the first channel and the opening, at 315, of the tracking loop in the first channel may be performed in the opposite order from the order illustrated, or simultaneously. The measure of combined signal level may be an average of a measure of signal level on the first channel and a measure of signal level on the second channel. The measure of signal level on the first channel may be based on signal energy in an early tap, a prompt tap, and a late tap for the first channel. The measure of signal level on the first channel may be based on signal energy in a lower frequency tap, a center tap, and a higher frequency tap for the first channel. The measure of signal level on the first channel may be based on a maximum signal energy among nine taps of a nine-tap time frequency grid of channel in-phase and quadrature data for the first channel. The measure of signal level on the first channel may be based on the maximum signal energy adjusted by noise normalization. The method may further include determining that the measure of combined signal level is greater than the threshold, closing the tracking loop on the third channel, and closing the tracking loop on the second channel.

In some embodiments, the opening of the tracking loop is in response to the determining that a measure of combined signal level is less than a threshold. In some embodiments, the opening of the tracking loop is further in response to freewheeling mode being enabled. In some embodiments, the method may further include enabling freewheeling mode, at 330, in response to: detecting a set period of strong signals, or receiving an instruction to enable freewheeling mode. In some embodiments, the method may further include disabling freewheeling mode, at 335, in response to detecting a set period of weak signals.

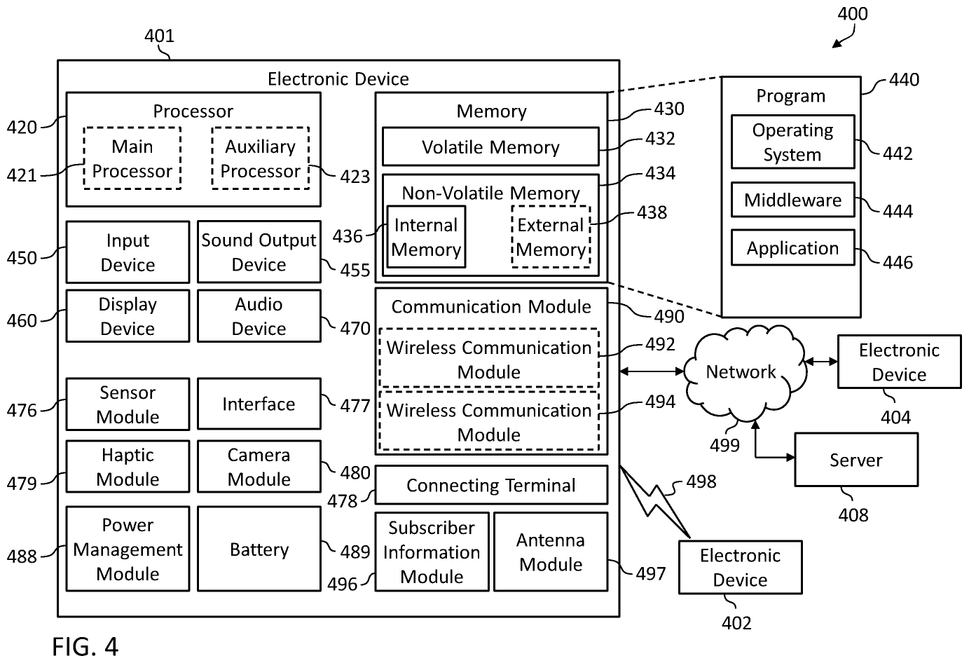

FIG. 4 is a block diagram of an electronic device in a network environment 400, according to an embodiment. In some embodiments, a Global Navigation Satellite System receiver 105 may include features of the electronic device of FIG. 4.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 440, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 494. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 446 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
determining that a measure of combined signal level is less than a threshold, the measure of combined signal level being a measure of a signal level on a first channel of a Global Navigation Satellite System receiver and measure of a signal level on a second channel of the Global Navigation Satellite System receiver; and
opening a tracking loop on a third channel of the Global Navigation Satellite System receiver.

2. The method of claim 1, wherein the third channel is the first channel.

3. The method of claim 2, further comprising opening a tracking loop on the second channel.

4. The method of claim 1, wherein the measure of combined signal level is an average of a plurality of quantities including the measure of signal level on the first channel and the measure of signal level on the second channel.

5. The method of claim 1, wherein the measure of signal level on the first channel is based on signal energy in an early tap, a prompt tap, and a late tap for the first channel.

6. The method of claim 1, wherein the measure of signal level on the first channel is based on signal energy in a lower frequency tap, a center tap, and a higher frequency tap for the first channel.

7. The method of claim 1, wherein the measure of signal level on the first channel is based on a maximum signal energy among taps of channel in-phase and quadrature data for the first channel.

8. The method of claim 7, wherein the measure of signal level on the first channel is based on the maximum signal energy adjusted by noise normalization.

9. The method of claim 1, further comprising:
determining that the measure of combined signal level is greater than the threshold; and
closing the tracking loop on the third channel.

10. The method of claim 9, wherein:
the third channel is the first channel; and
the method further comprises closing the tracking loop on the second channel.

11. The method of claim 1, wherein the opening of the tracking loop is in response to the determining that the measure of combined signal level is less than the threshold.

12. The method of claim 11, wherein the opening of the tracking loop is further in response to freewheeling mode being enabled.

13. The method of claim 12, further comprising enabling freewheeling mode, in response to:
detecting a set period of strong signals, or
receiving an instruction to enable freewheeling mode.

14. The method of claim 12, further comprising disabling freewheeling mode, in response to detecting a set period of weak signals.

15. A Global Navigation Satellite System receiver, comprising:
one or more processors; and
a memory storing instructions which, when executed by the one or more processors, cause performance of:
determining that a measure of combined signal level is less than a threshold, the measure of combined signal level being a measure of a signal level on a first channel of a Global Navigation Satellite System receiver and a signal level on a second channel of the Global Navigation Satellite System receiver; and
opening a tracking loop on a third channel of the Global Navigation Satellite System receiver.

16. The Global Navigation Satellite System receiver of claim 15, wherein the third channel is the first channel.

17. The Global Navigation Satellite System receiver of claim 16, wherein the instructions, when executed by the one or more processors, further cause performance of:
opening a tracking loop on the second channel.

18. The Global Navigation Satellite System receiver of claim 15, wherein the measure of combined signal level is an average of a plurality of quantities including a measure of signal level on the first channel and a measure of signal level on the second channel.

19. The Global Navigation Satellite System receiver of claim 15, wherein the measure of signal level on the first channel is based on signal energy in an early tap, a prompt tap, and a late tap for the first channel.

20. A Global Navigation Satellite System receiver, comprising:
means for processing; and
a memory storing instructions which, when executed by the means for processing, cause performance of:
determining that a measure of combined signal level is less than a threshold, the measure of combined signal level being a measure of a signal level on a first channel of a Global Navigation Satellite System receiver and a signal level on a second channel of the Global Navigation Satellite System receiver; and
opening a tracking loop on a third channel of the Global Navigation Satellite System receiver.
